(19) United States
(12) Patent Application Publication
(10) Pub. No.: US 2026/0186970 A1
(43) Pub. Date: Jul. 2, 2026

(54) MULTI-NODE COMPUTING SYSTEM WITH MEMORY COHERENCE MANAGEMENT METHOD

(71) Applicant: Samsung Electronics Co., Ltd., Suwon-si (KR)

(72) Inventors: Jin-Hong KIM, Suwon-si (KR); Dong-Uk RYU, Suwon-si (KR); Junyeon LEE, Suwon-si (KR); Wonik SEO, Suwon-si (KR)

(73) Assignee: Samsung Electronics Co., Ltd., Suwon-si (KR)

(21) Appl. No.: 19/259,858

(22) Filed: Jul. 3, 2025

(30) Foreign Application Priority Data
Dec. 26, 2024 (KR) 10-2024-0197337

(51) Int. Cl. G06F 12/0817; G06F 12/084

(52) U.S. Cl. CPC G06F 12/0828; G06F 12/084

(57) ABSTRACT

A memory management method performed by a multi-node computing system includes: transmitting, by a first node, to a second node, first data stored in a first data space of memory of the first node; receiving, by the first node, a write request from the second node, the write request including first modified data and a node identifier identifying the second node, and the first modified data being generated by the second node modifying the first data; determining, by the first node, whether to activate multi-node coherence verification with respect to the first data space based on a bit value of a first verification activation bit; and determining whether to store, by the first node, the first modified data in the first data space without activating the multi-node coherence verification based on the bit value of the first verification activation bit.

### CROSS-REFERENCE TO RELATED APPLICATIONS

This application claims the benefit under 35 U.S.C. § 119(a) of Korean Patent Application No. 10-2024-0197337, filed on Dec. 26, 2024, in the Korean Intellectual Property Office, the entire disclosure of which is incorporated herein by reference for all purposes.

### BACKGROUND

### 1. Field

The following description relates to a multi-node computing system with a memory coherence management method.

### 2. Description of Related Art

Recent advancements in artificial intelligence (AI) and high-performance computing (HPC) have led to increasing demand for systems that can process large datasets and perform complex computations. In particular, large-scale networks used for deep learning model training and inference require continuous loading of substantial amounts of data into memory during the computation process. As a result, memory access latency and memory bandwidth have become critical issues. Conventional memory access methods involve fetching data from remote memory every time a central processing unit (CPU) needs the data, which results in long delays and degradation of overall system performance. This problem is exacerbated in Distributed shared memory (DSM) or global memory architectures, which are distributed memory systems that allow multiple nodes to share a single virtual memory space, thereby helping to improve memory access performance and overcome memory capacity limitations. A DSM system may use physically distributed memory as a single virtual memory space, enabling each node to access the memory of other nodes.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a memory management method is performed by a multi-node computing system including nodes, and the memory management method includes: transmitting, by a first node among the nodes, to a second node among the nodes, first data stored in a first data space of memory of the first node; receiving, by the first node, a write request from the second node, the write request including first modified data and a node identifier identifying the second node, and the first modified data being generated by the second node modifying the first data; determining, by the first node, whether to activate multi-node coherence verification with respect to the first data space based on a bit value of a first verification activation bit; and determining whether to store, by the first node, the first modified data in the first data space without activating the multi-node coherence verification based on the bit value of the first verification activation bit.

The multi-node coherence verification may include verification to prevent data stored in the first data space from being modified by various of the nodes within a same timestep.

The memory management method may further include: based on the bit value of the first verification activation bit indicating activation, determining, by the first node, whether to store the first modified data in the first data space based on a first modification bit of a first metadata space corresponding to the first data space of a hash table entry, the first modification bit indicating whether data in the first data space has been modified at a current timestep; and storing, by the first node, the first modified data in the first data space in response to a data value of the first modification bit indicating that the data in the first data space has not been modified during the current timestep.

The memory management method may further include: based on the data value of the first modification bit indicating that the data in the first data space has been modified at the current timestep, determining, by the first node, whether to store the first modified data in the first data space based on a first source node identifier of the first metadata space, the first node identifier identifying a node, among the nodes, that modified the data in the first data space; and storing, by the first node, the first modified data in the first data space in response to the node identifier of the second node being the same as the first source node identifier.

The memory management method may further include: based on the data value of the first modification bit indicating that the data in the first data space has been modified at the current timestep, determining, by the first node, whether to store the first modified data in the first data space based on a first source node identifier of the first metadata space, the first node identifier identifying a node, among the nodes, that modified the data in the first data space; and invalidating, by the first node, the first modified data in response to the node identifier of the second node being different from the first source node identifier.

The bit value of the first verification activation bit may be stored in a hash table entry that is used for the multi-node coherence verification.

Whether to activate multi-node coherence verification with respect to a second data space of the memory of the first node may be determined based on the bit value of the first verification activation bit.

A bit value of a second verification activation bit, which determines whether to activate the multi-node coherence verification with respect to the second data space of the memory of the first node, may be stored in a second metadata space corresponding to the second data space of the hash table entry, and the bit value of the first verification activation bit may be stored in a first metadata space of the hash table entry, the first metadata space corresponding to the first data space.

The memory management method may further include: comparing, by the first node, a threshold value with a write count value indicating the number of times data in the first data space has been consecutively modified by a same node; and based on a result of the comparing, transmitting, by the first node, to the second node, a count result signal, wherein the write count value is stored in a first metadata space of a hash table entry for the multi-node coherence verification with respect to the data in the first data space.

The memory management method may further include: based on a bit value of a count activation bit, determining, by the first node, whether to compare the write count value with the threshold value, wherein the bit value of the count activation bit is stored in the hash table entry.

In another general aspect, a memory management method is performed by a multi-node computing system including nodes, and the memory management method includes: transmitting, by a first node among the nodes, to a second node among the nodes, first data stored in a first data space of memory of the first node; receiving, by the first node, a write request from the second node, wherein the write request includes first modified data and a node identifier identifying the second node, and wherein the first modified data is generated by the second node modifying the first data; comparing, by the first node, a threshold value with a write count value indicating the number of times data in the first data space has been consecutively modified by a same node; based on a result of the comparing, transmitting a count result signal from the first node to the second node; and storing, by the first node, the first modified data in the first data space.

The memory management method may further include: based on a bit value of a count activation bit, determining, by the first node, whether to compare the write count value with the threshold value, wherein the write count value and the bit value of the count activation bit are stored in a hash table entry for the multi-node coherence verification of the data in the first data space.

In another general aspect, a multi-node computing system includes nodes sharing a shared memory, the nodes including a first node and a second node, and the first node is configured to: transmit first data stored in a first data space of memory of the first node to the second node, the first data space included in the shared memory, receive a write request from the second node, the write request including first modified data generated by the second node modifying the first data and a node identifier identifying the second node, determine whether to activate multi-node coherence verification with respect to the first data space based on a bit value of a first verification activation bit, and determine whether to store the first modified data in the first data space without activating the multi-node coherence verification based on the bit value of the first verification activation bit.

The first node may be further configured to: based on the bit value of the first verification activation bit indicating activation, determine whether to store the first modified data in the first data space based on a first modification bit of a first metadata space corresponding to the first data space of a hash table entry, the first modification bit indicating whether data in the first data space has been modified at a current timestep, and store the first modified data in the first data space in response to a data value of the first modification bit indicating that the data in the first data space has not been modified during the current timestep.

The first node may be further configured to: based on the data value of the first modification bit indicating that the data in the first data space has been modified at the current timestep, determine whether to store the first modified data in the first data space based on a first source node identifier of the first metadata space, the first node identifier identifying a node, among the nodes, that modified the data in the first data space, and store the first modified data in the first data space in response to the node identifier of the second node being the same as the first source node identifier.

The first node may be further configured to: based on the data value of the first modification bit indicating that the data in the first data space has been modified at the current timestep, determine whether to store the first modified data in the first data space based on a first source node identifier of the first metadata space, the first node identifier identifying a node, among the nodes, that modified the data in the first data space; and invalidate the first modified data in response to the node identifier of the second node being different from the first source node identifier.

The bit value of the first verification activation bit may be stored in a hash table entry that is used for the multi-node coherence verification.

Whether to activate multi-node coherence verification with respect to a second data space of the memory of the first node may be determined based on the bit value of the first verification activation bit.

The first node may be configured to: compare a threshold value with a write count value indicating the number of times data in the first data space has been consecutively modified by a same node, and based on a result of the comparing, transmit a count result signal to the second node, wherein the write count value is stored in a first metadata space of a hash table entry for the multi-node coherence verification with respect to the data in the first data space.

The first node may be further configured to: based on a bit value of a count activation bit, determine whether to compare the write count value with the threshold, and the bit value of the count activation bit is stored in the hash table entry.

### BRIEF DESCRIPTION OF THE DRAWINGS

FIG. 1 illustrates a multi-node computing system according to one or more embodiments.

FIG. 2 illustrates the process of storing a modification bit and a source node identifier in a hash table of a home node according to one or more embodiments.

FIG. 3 illustrates a multi-node coherence verification process according to one or more embodiments.

FIG. 4 illustrates the process of storing metadata of a cache of a home node in a hash table according to one or more embodiments.

FIG. 5 illustrates a memory space including metadata that does not have a hash table entry including a verification activation bit, a count activation bit, and a count bit.

FIG. 6 illustrates a memory space including metadata that has a hash table entry including a count activation bit and a count bit according to one or more embodiments.

FIG. 7 illustrates a memory management process including data modification based on the bit value of a verification activation bit according to one or more embodiments.

FIG. 8 illustrates a memory management process including an operation of determining whether to transmit a count result signal to a cached node before performing data modification based on the bit value of a count activation bit and the data value of a count bit according to one or more embodiments.

FIG. 9 illustrates a memory space including a verification activation bit in each metadata space of a hash table entry according to one or more embodiments.

FIG. 10 illustrates a memory space including a count bit in each metadata space of a hash table entry according to one or more embodiments.

FIG. 11 illustrates the process of transmitting a count result signal from a home node to a cached node according to one or more embodiments.

FIG. 12 illustrates a memory management method of a multi-node computing system according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

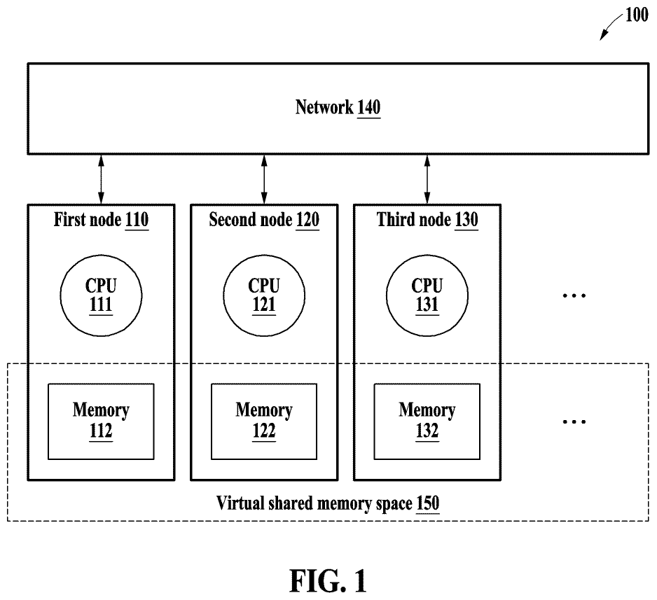

FIG. 1 illustrates a multi-node computing system according to one or more embodiments. Referring to FIG. 1, a distributed memory system 100 according to an embodiment may include multiple nodes including a first node 110, a second node 120, and a third node 130; in actual implementation, the distributed memory system 100 may two or more nodes. The system configuration may be adjusted depending on requirements of application programs or network resource constraints. The multiple nodes (e.g., the first to third nodes 110, 120, and 130) may be interconnected via a network 140.

Each of the nodes may be a computing system that maintains cache coherence through hardware. Each of the multiple nodes may include one or more processors. For example, the first node 110, the second node 120, and the third node 130 may include a central processing unit (CPU) 111, a CPU 121, and a CPU 131, respectively (each node may use other types of processors). Each of the nodes may include memory. For example, the first node 110, the second node 120, and the third node 130 may include memory 112, memory 122, and memory 132, respectively. Each node may include cache memory, storage, an input/output (I/O) device, and a network interface.

The memory of each node may include local memory and global memory. The local memory and the global memory may be physically or logically separated. A node's local memory (e.g., a portion of the memory 112 of the first node 110) may be an independent memory space that is accessible only to that node, and may be dedicated memory from or to which the node's processor may read and write data. A node's local memory may be an independent area that is not accessible to the other nodes. Data sharing between nodes may be performed through a virtual shared memory space 150 rather than through the local memory. The virtual shared memory space 150 may be formed by the pieces of global memory of each node. A portion of a node's memory may be used as part of the virtual shared memory space 150. In this case, a portion of the memory may be global memory and operate as the virtual shared memory space 150, and another portion of the memory may be local memory and operate as an independent area within the corresponding node. For example, the local memory of a node may be memory used only by the operating system of that node and may be managed by the operating systems'memory manager.

The portions of the memories of the nodes (e.g., the memory 112, the memory 122, and the memory 132) may form the virtual shared memory space 150. The virtual shared memory space 150 may be a shared memory space that is commonly accessible to all nodes of the multi-node computing system, may be accessed with a same virtual address space at each of the nodes, and may serve as central memory for multiple nodes to access the same data or share data. The virtual shared memory space 150 may be implemented based on a centralized memory server, a distributed shared memory (DSM) system, or a high-performance storage, and all nodes may share data through the same virtual shared memory space.

For example, if data stored in the memory 112 of the first node 110 needs to be used in other nodes (e.g., the second node 120 and the third node 130), the data may be stored in the virtual shared memory space 150. Then, other nodes may access the virtual shared memory space 150 (through the network 140) to read or use the data. The network 140 may be any network for data communication. For example, the network 140 may be an Ethernet, InfiniBand, or Peripheral Component Interconnect Express (PCIe) network. This allows each node to share data indirectly through the virtual shared memory space 150 without directly accessing the local memory of the other nodes.

When target data is stored in the virtual shared memory space 150, a node including a physical memory space storing the target data may be referred to as a home node, and a node not including a physical memory space storing the target data may be referred to as a cached node. The cached node may access the physical memory space of the home node to use the target data (which may also be locally cached). Each node of the multi-node computing system 100 may store data in the virtual shared memory space 150 for various purposes. For example, if an eviction is required to secure the memory capacity of a cached node, or if an explicit flush is requested to secure the cached node's cache memory capacity, the cached node may use the virtual shared memory space 150.

The multi-node computing system 100 and nodes cooperatively perform tasks in a system that processes large-scale data, and may be utilized in various fields such as artificial intelligence (AI) model learning, scientific simulation, and big data analysis. For example, molecular dynamics simulations deal with massive amounts of data and parameters that may be difficult to process using only the memory and computing power of a single computer. In such cases, multiple nodes may perform tasks jointly through a distributed memory system. For example, multiple nodes may perform tasks jointly by exchanging data between ghost cells of the nodes.

When multiple nodes of the multi-node computing system 100 perform tasks jointly/cooperatively, cache coherence of their cache memories may be required. Due to the nature of multi-node computing systems where multiple nodes cooperate to perform calculations, constantly maintaining cache coherence between nodes may cause network latency in proportion with the total number of processors, lowering the system performance. Accordingly, each of the nodes may (i) perform calculations in a state of losing cache coherence with the other nodes at one timestep, and may (ii) store modified data in the virtual shared memory space 150 and synchronize the modified data with the other nodes at the end of the timestep. This process is sometimes referred to as timestep symmetric multiprocessing (TSMP).

Since cache coherence between nodes is not maintained when performing multi-node computing through TSMP, different nodes may attempt to modify the same data in the virtual shared memory space 150 at one timestep. Within one timestep, even if predetermined data in the virtual shared memory space 150 is modified, the other nodes may not be aware of the modification until synchronization is performed. For example, within one timestep, if a first write request from the first node 110 is received for first data in the virtual shared memory space 150, and after that, a second write request from the second node 120 is received, since the second node 120 may not be aware of the calculation result of the first node 110, modifying the first data by the second write request may cause data coherence issues in the multi-node computing system 100.

Therefore, to maintain data coherence in the multi-node computing system 100, it is desirable to prevent different nodes from modifying the same data in the virtual shared memory space 150 within one timestep. To this end, metadata stored in a hash table may be used for multi-node coherence verification to prevent the same data stored in memory from being modified by different nodes within the same timestep. The metadata stored in the hash table may include entries, and each entry may include the node identifier of a cached node requesting data modification in the memory of the home node, and a modification bit, the purposes of which are described below.

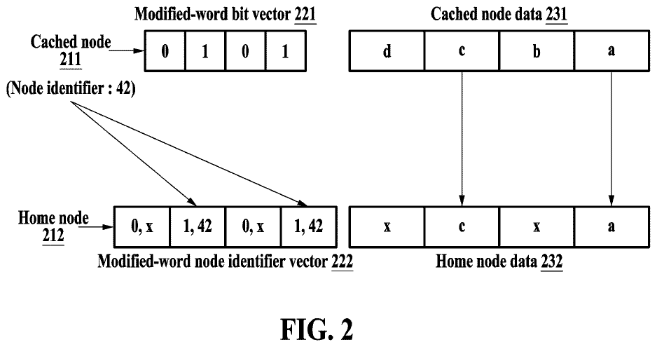

FIG. 2 illustrates the process of storing a modification bit and a source node identifier in a hash table of a home node according to one or more embodiments. Referring to FIG. 2, as described next, home node data 232 of a home node 212 may be modified by a cached node 211. First, the cached node 211 may read the home node data 232 stored in the memory of the home node 212 of a virtual shared memory space; the read data may be stored in the cache memory of the cached node 211. Then, the cached node 211 may modify the home node data 232 in the cache memory of the cached node 211. Data generated/modified by the cached node 211 modifying the home node data 232 may be referred to as cached node data 231.

The cached node 211 may transmit, to the home node 212, a write request (see top half of FIG. 2) including the cached node data 231 and a modified-word bit vector 221. The modified-word bit vector 221 may include modification bits for indicating statuses of respectively corresponding pieces of subdata (“subdata” for short) of the cached node data 231. Each subdata of the cached node data 231 may have the size of a word, for example, the basic unit of CPU operation. Modification bits may be metadata indicating whether respective subdata of the cached node data 231 have been modified in the cached node 211. For example, if the bit values of the second and fourth bits of the modified-word bit vector 221 are “1”, it may indicate that the values of the second and fourth subdata of the cached node data 231 have been modified.

When the home node 212 receives the write request from the cached node 211, the home node 212 may store modified subdata of the cached node data 231 into the memory of the home node 212 based on the modified-word bit vector 221. The home node 212 may generate/manage a modified-word node identifier vector 222 based on the modified-word bit vector 221 and the node identifier of the cached node 211. The modified-word node identifier vector 222 may include modification bits set according to the modified-word bit vector 221. Each element of the modified-word node identifier vector 222 that is set to indicate corresponding subdata of the home node data 232 has been modified may also include the node identifier of the cached node 211. That is to say, modification bits set to “1” in the modified-word node identifier vector 222 may also include the source node identifier of the responsible cached node (e.g., cached node 211). A source node identifier may be metadata identifying a node that transmits/transmitted a write request.

For example, if the node identifier of the cached node 211 is “42”, the second and fourth elements of the modified-word node identifier vector 222 (corresponding to the second and fourth subdata), which indicate modified words in the home node data 232, may include the source node identifier “42”. The home node 212 may store the modified-word node identifier vector 222 in a hash table in the memory of the home node 212. Although FIG. 2 shows the unit of data tracked by the hash table as being a word unit, other units may be used.

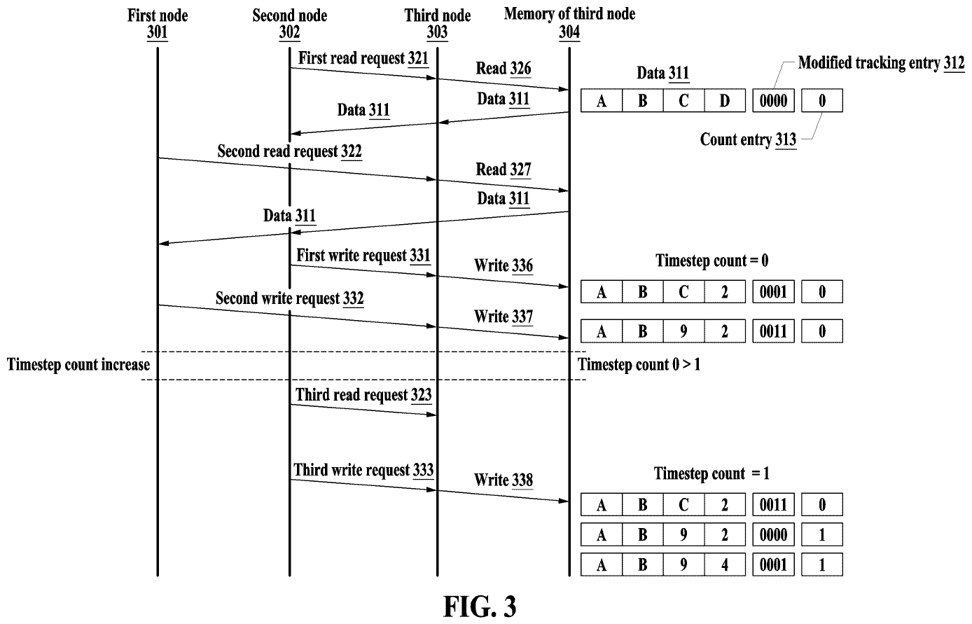

FIG. 3 illustrates a multi-node coherence verification process according to one or more embodiments. Referring to FIG. 3, a first node 301 and a second node 302 may transmit read requests and write requests to a third node 303. Through the read requests and write requests, the first node 301 and the second node 302 may modify data 311 of the third node 303. The third node's 303 memory 304 may include a hash table corresponding to the data 311. When the data 311 is modified, the data values of a modified tracking entry 312 and a count entry 313 corresponding to the data 311 may change. The hash table corresponding to the data 311 may include the modified tracking entry 312. The modified tracking entry 312 may include modification bits. The multi-node coherence verification process of FIG. 3 is merely an example, and embodiments are not limited thereto.

When multi-node coherence verification is initiated, the current timestep at that initiation may first be compared with the stored indication of the latest (most recent) timestep at which the relevant data was modified. Since modified data is synchronized across the multi-node computing system each time a timestep ends, data coherence issues may not occur in the multi-node computing system, even when data is modified at different timesteps.

The data of the count entry 313 may represent the timestep count at which the data 311 associated therewith was modified last (different data units, e.g., blocks or cache lines, may each have their own count entry). If the current timestep count data is different from the data of the count entry 313, data coherence issues in the multi-node computing system may not occur due to the synchronization of TSMP.

Next, if the timestep at which data was most recently modified is the same as the current timestep, the bit value of the modification bit corresponding to the data to be modified may be checked. If the bit value of the modification bit indicates that the data to be modified has not been modified, there may not be a data coherence issue. Thereafter, if the bit value of the modification bit indicates that the data to be modified has been modified, the source node identifier corresponding to the data to be modified may be checked. If the node identifier included in the write request is the same as the source node identifier, it indicates that the corresponding cached node is aware of the data modification performed previously, and thus there may be no data coherence issue.

However, to maintain data coherence, if the node identifier included in the write request is different from the source node identifier (i.e., a node other than the node that modified the subdata), then the write request may be invalidated. That is to say, write requests from nodes other than the node that sent the first write request for the same data within the same timestep may be invalidated.

The modified tracking entry 312 may include modification bits corresponding to the data 311. When some subdata of the data 311 are modified, the bit values of the modification bits (of the modified tracking entry 312) corresponding to the modified subdata may be changed to indicate that those subdata have been modified. Although in the example a bit value of “1” indicates that subdata has been modified and a modification bit with a bit value of “0” indicates that subdata has not been modified, the reverse convention may be used.

The second node 302 may transmit a first read request 321 to the third node 303, and the third node 303 may perform a read 326 on the memory 304 (e.g., memory 132) of the third node for the requested data. In response to the first read request 321, the third node 303 may transmit the requested data (e.g., data 311) stored in is memory 304 to the second node 302. After, and in the same timestep, the first node 301 may transmit a second read request 322 to the third node 303, and the third node 303 may perform a read 327 on its memory 304. In response to the second read request 322, the third node 303 may transmit the requested data (e.g., data 311) stored in its memory 304 to the first node 301. Although the first node 301 and the second node 302 read the same data 311 (e.g., the same cache line) from the memory 304 of the third node 303, the data/bits of the modified tracking entry 312 may are not yet modified (or set to indicate modification) since the data 311 has not yet been modified.

In the same timestep, the second node 302 may modify the data 311 that it previously received from the third node 303 (per the first read request 321). The second node 302 may transmit a first write request 331 including the modified data to the third node 303, and the third node 303 may perform a write 336 to its memory 304. Before the write 336 of the third node 303 is performed, the third node 303 may perform multi-node coherence verification. Although the data value of the count entry 313 and the data value of the timestep count are identically “0”, the bit value of the modification bit (of the modified tracking entry 312) corresponding to “D” of the data 311 is “0”, so the data “2” generated by the second node 302 modifying “D” (or more specifically, modifying the memory location storing “D”) may be stored into the memory 304 of the third node. The bit value of the modification bit of the modified tracking entry 312 corresponding to “D” of the data 311 may change from “0” to “1” in response to the write 336.

After the first write request 331 and during the same timestep, the first node 301 may also modify the data 311 that it received from the third node 303 (per the second read request 322). The first node 301 may transmit a second write request 332 including the modified data to the third node 303, and the third node 303 may perform a write 337 to its memory 304. Before the write 337 is performed, the third node 303 may perform multi-node coherence verification. Although the data value of the count entry 313 and the data value of the timestep count are identically “0”, the bit value of the modification bit (of the modified tracking entry 312) corresponding to “C” of the data 311 is “0”, so the data “9” generated by the first node 301 modifying “C” (or more specifically, modifying the memory location storing “C”) may be stored in the memory 304 of the third node. The bit value of the modification bit of the modified tracking entry 312 corresponding to “C” of the data 311 may change from “0” to “1” in response to the write 337.

After the timestep count increases from “0” to “1” (e.g., as performed by a timer call or the like), the second node 302 may transmit a third read request 323 to the third node 303. In response to the third read request 323, the third node 303 may transmit the data stored in its memory 304 to the second node 302. The second node 302 may modify the data received from the third node 303 in response to the third read request 323. The second node 302 transmits a third write request 333 including the modified data to the third node 303, and the third node 303 may perform a write 338 to its memory 304. Before the write 338 is performed, the third node 303 may perform multi-node coherence verification.

Specifically, since the data value of the count entry 313 (indicating the timestep when the data 311 was last updated) and the data value of the timestep count are different as “0” and “1”, respectively, the data “4” generated by the second node 302 modifying “2” may be stored in the memory 304 of the third node without causing a data coherence issue(because the new write is later, it is safe to say that it overrides any data written earlier, e.g., during timestep 0). If the data value of the count entry 313 and the data value of the timestep count are different (the data value in the count entry 313 can only be earlier than or equal to the current timestep; it can't be older, thus, only a difference matters), the data value of the count entry 313 may be updated (to the current timestep count, to indicate an update for that timestep) and the data value of the modified tracking entry 312 may be initialized (e.g., reset) in response to a new write request. Thereafter, the bit value of the modification bit of the modified tracking entry 312 corresponding to “2” of the data in the memory 304 may change from “0” to “1” in response to the write 338.

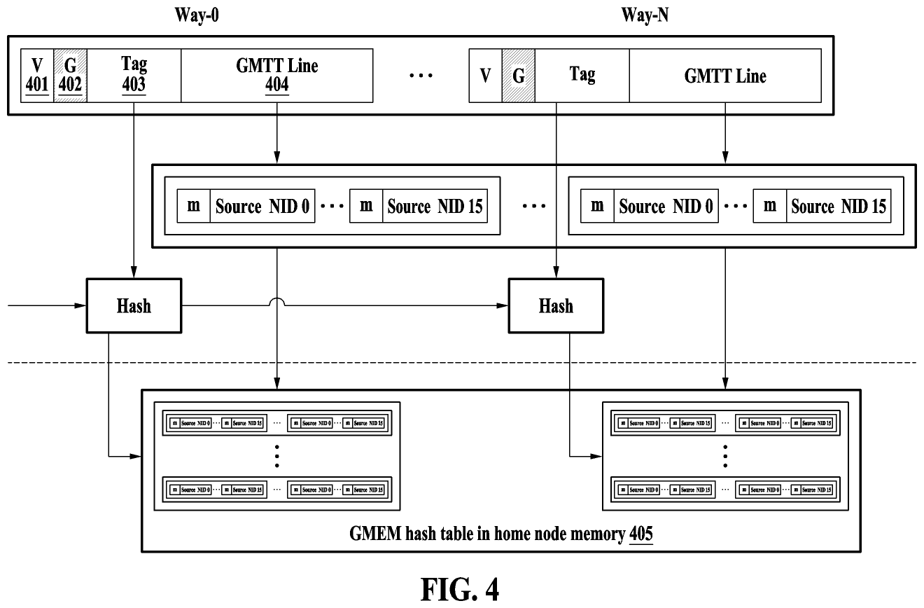

FIG. 4 illustrates the process of storing metadata of a cache of a home node in a hash table according to one or more embodiments. Referring to FIG. 4, a cache line (top of FIG. 4) of a home node may include metadata including a valid bit V 401, a global bit G 402, a tag field 403, and a global memory (GMEM) modified tracking table (GMTT) line 404. The valid bit 401, the global bit 402, the tag field 403, and the GMTT line 404 may be metadata regarding a write request received by the home node from a cached node.

The bit value of the valid bit 401 may indicate whether the cache line is valid. The bit value of the global bit 402 may indicate whether the data in the cache line is local data or global data; global data may be data in a virtual shared memory space. The data value of the tag field 403 may have the usual function of identifying a memory address of the memory of the home node.

The GMTT line 404 may be data in which at least part of the metadata of a hash table 405 is cached. The GMTT line 404 may include one or more valid bits m and one or more source node identifiers (source NIDs) stored in the hash table 405. The metadata of the GMTT line 404 may be stored in a metadata space (here, “space” means “portion”, “piece”, “unit”, or the like; a “metadata space” is an addressable piece of metadata storage) of the GMEM hash table 405 of the home node memory, and the memory address of the metadata space may be determined by applying a hash function to the memory address of the data space corresponding to the GMTT line 404 based on the tag field 403 (here, “data space” refers to a unit/piece/portion of data storage).

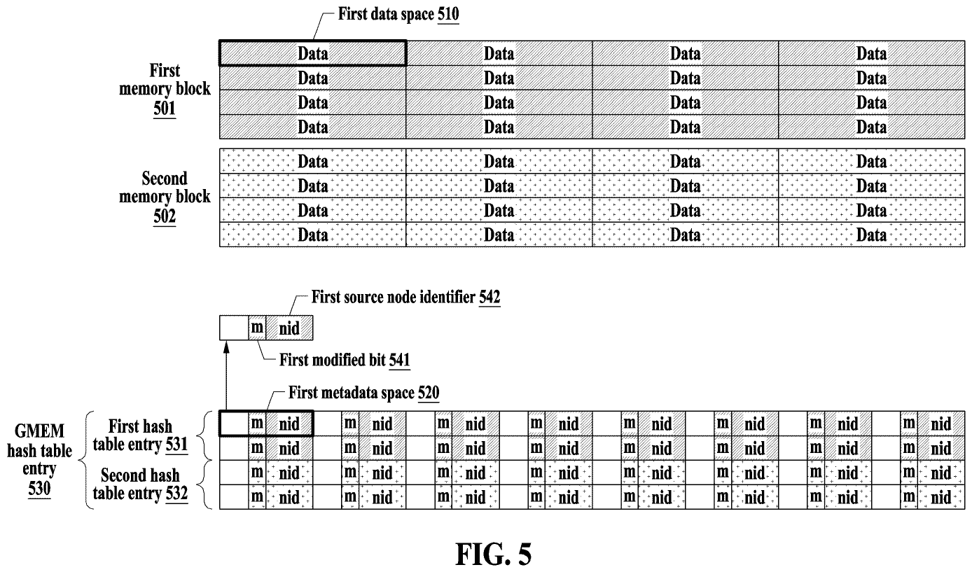

FIG. 5 illustrates a memory space including metadata that does not have a hash table entry including a verification activation bit, a count activation bit, and a count bit. Referring to FIG. 5, memory of a home node may include a first memory block 501, a second memory block 502, and a GMEM hash table entry 530. The GMEM hash table entry 530 may include a first hash table entry 531 and a second hash table entry 532. The first hash table entry 531 may store metadata corresponding to data stored in the first memory block 501. The second hash table entry 532 may store metadata corresponding to data stored in the second memory block 502. As can be seen in the example of FIG. 5, a hash table entry has the same number of metadata spaces/units (e.g., 16) as the number of data spaces in the corresponding memory block (also 16). In other words, each data space has a corresponding metadata space, whose address can be obtained as described above.

As noted, the first memory block 501 and the second memory block 502 may include one or more data spaces (e.g., a first data space 510 may be in the first memory block 501). The data spaces may be memory spaces (management units) where data can be stored. Metadata spaces may be memory spaces where metadata can be stored. The data spaces and the metadata spaces may be indicated (and referenced) by memory addresses. Predetermined data and metadata of the predetermined data may form a data pair. Predetermined rules may apply to the memory addresses of a data space and a metadata space of a data pair. For example, a hash function may be defined according to predetermined rules. By applying the rules to the memory address of a data space, the memory address of the corresponding metadata space may be derived. Each data space included in the memory blocks 501 and 502 may be a memory space corresponding to data of a predetermined unit. For example, a data space such as the first data space 510 may be determined based on the basic operation unit of a CPU. For example, the basic operation unit may be, but is not limited to, a word. For example, the size of a word may be, but is not limited to, 16 bits or 32 bits.

The GMEM hash table entry 530 may include metadata including a modification bit and a source node identifier. In FIG. 5, m denotes a modification bit, and nid denotes a source node identifier. The modification bits and source node identifiers stored in the GMEM hash table entry 530 may be used for multi-node coherence verification corresponding to the data stored in the first memory block 501 and the second memory block 502. The multi-node coherence verification may prevent the data stored in the first data space 510 from being modified by various nodes within the same timestep. For example, when the home node receives a write request to modify the data stored in the first data space 510, multi-node coherence verification may be performed using a first modification bit 541 and a first source node identifier 542 stored in a first metadata space 520. The first metadata space 520 may correspond to the first data space 510.

The memory addresses of the metadata stored in the GMEM hash table entry 530 may be determined by applying a hash function to the memory addresses of the data in the memory blocks 501 and 502 for fast access. Additionally, to achieve easier reading, modifying, and writing of metadata from and to the hash table, each metadata space may be arranged in a predetermined bit unit. For example, the metadata space may be arranged in a word unit. For example, the word unit may be 16 bits, 32 bits, etc. Depending on the data size of the modification bit and the source node identifier, each metadata space corresponding to each data space of the memory blocks 501 and 502 may include unused memory space. Such unused memory space in the GMEM hash table entry 530 may result in wasted memory space.

Additionally, multi-node coherence verification may not always be required in the multi-node computing system. For example, when running a predetermined application using the multi-node computing system, multi-node coherence verification may not be performed, except during the application testing phase, if the application is programmed to maintain multi-node coherence. When performing multi-node computing through TSMP, the entire corresponding metadata is checked/dereferenced each time a write request is received, which may cause unnecessary overhead in the multi-node computing system.

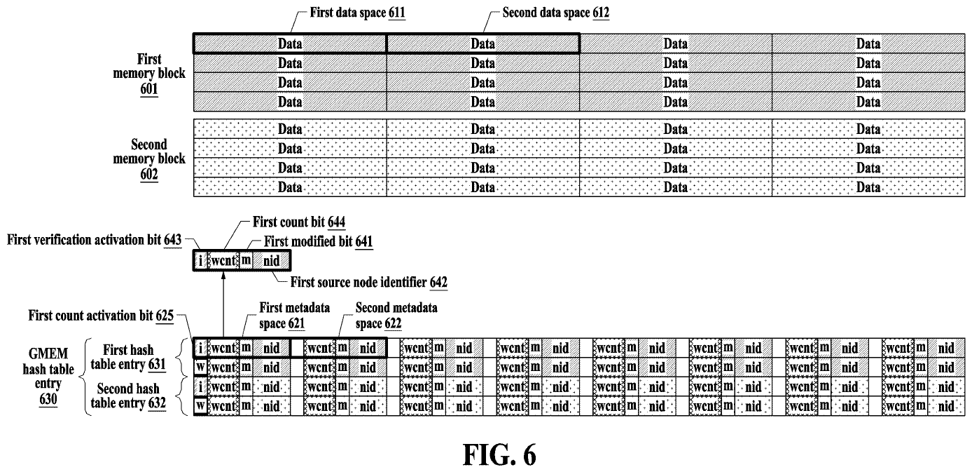

FIG. 6 illustrates a memory space including metadata that has a hash table entry including a count activation bit and a count bit according to one or more embodiments. Referring to FIG. 6, memory of a home node may include a first memory block 601, a second memory block 602, and a GMEM hash table entry 630. The GMEM hash table entry 630 may include a first hash table entry 631 and a second hash table entry 632. The memory blocks 601 and 602 may correspond to the memory blocks 501 and 502 of FIG. 5. The first hash table entry 631 may store metadata corresponding to data stored in the first memory block 601. The second hash table entry 632 may store metadata corresponding to data stored in the second memory block 602.

The GMEM hash table entry 630 may include metadata including a modification bit and a source node identifier. The modification bits and source node identifiers stored in the GMEM hash table entry 630 may be used for multi-node coherence verification corresponding to the data stored in the first memory block 601 and the second memory block 602. For example, when the home node receives a write request to modify the data stored in a first data space 611, multi-node coherence verification may be performed using a first modification bit 641 and a first source node identifier 642 stored in a first metadata space 621. The first metadata space 621 may be a metadata space corresponding to the first data space 611. A second metadata space 622 may be a metadata space corresponding to a second data space 612.

The first hash table entry 631 may include a first verification activation bit 643, a first count bit 644, and a first count activation bit 625. Although the bit value of the first verification activation bit 643 is stored in the first metadata space 621, the first verification activation bit 643 serves the entire first memory block 601; whether to activate multi-node coherence verification of the entire first memory block 601 may be determined based on the bit value of the first verification activation bit 643. For example, whether to activate multi-node coherence verification of the second data space 612 corresponding to the second metadata space 622 may be determined based on the bit value of the first verification activation bit 643.

When the bit value of the first verification activation bit 643 indicates deactivation, multi-node coherence verification of the data stored in the first memory block 601 may be deactivated. If multi-node coherence verification of the data stored in the first memory block 601 is deactivated, the home node may store modified data in the data space of the first memory block 601 without multi-node coherence verification when receiving a write request to modify the data in the first memory block 601 from a cached node. Conversely, when the bit value of the first verification activation bit 643 indicates activation, multi-node coherence verification of the data stored in the first memory block 601 may be activated. When multi-node coherence verification of the data stored in the first memory block 601 is not required, overhead occurring in the multi-node computing system may be reduced by setting the first verification activation bit 643.

Whether to activate the count bit of the entire first hash table entry 631 may be determined based on the bit value of the first count activation bit 625. When the bit value of the first count activation bit 625 indicates activation, the count bit of each metadata space of the first hash table entry 631 may be activated. Conversely, when the bit value of the first count activation bit 625 indicates deactivation, the count bit of each metadata space of the first hash table entry 631 may be deactivated. The data value of the count bit of each metadata space may indicate the number of times the data in the corresponding data space has been consecutively modified by the same node (in practice the count bit may be as many bits as needed for the maximum count value). The data value of the count bit may be referred to as the write count value.

The home node may compare the write count value of each metadata space with a threshold value. The threshold value may be a preset value. The home node may transmit a count result signal to the corresponding cached node (as identified by the NID) based on the comparison result. For example, if the write count value of the first count bit 644 of the first metadata space 621 is equal to the preset threshold value, the home node may transmit the count result signal to the cached node. Based on the count result signal, the cached node may perform a predetermined operation for memory management. For example, the cached node may preload the data stored in the first data space 611 to the local memory of the cached node based on the count result signal.

However, due to the nature of distributed memory systems, programming without considering the physical location of memory may lead to performance degradation. For example, if data frequently used by the first node is allocated to the memory space of the second node, network latency may occur whenever the first node accesses the data, resulting in poor performance. Accordingly, a distributed memory system according to an embodiment may copy data in advance from global memory to local memory using the preloading scheme to minimize such performance degradation. For example, if the first node frequently needs to use predetermined data stored in the global memory space of the second node, preloading the data to the local memory of the first node may allow for quick access to the data from the local memory whenever needed. This may reduce access latency to global memory and optimize overall system performance.

Although the bit value of the first verification activation bit 643 is stored in the first metadata space 621, the storage location of the bit value of the first verification activation bit 643 is not limited thereto, for example, it may be stored in a predetermined metadata space of the first hash table entry 631. Similarly, the storage location of the bit value of the first count activation bit 625 is not limited to the shown location, for example, it may be stored in a predetermined metadata space of the first hash table entry 631. Each metadata space of the first hash table entry 631 may store the data value of a corresponding count bit. For example, the first metadata space 621 may store the data value of the first count bit 644. Additionally, for example, the second metadata space 622 may store the data value of a second count bit. Since the bit value of the verification activation bit, the data value of the count bit, and the bit value of the count activation bit are included in the GMEM hash table entry 630, memory space wastage may be reduced.

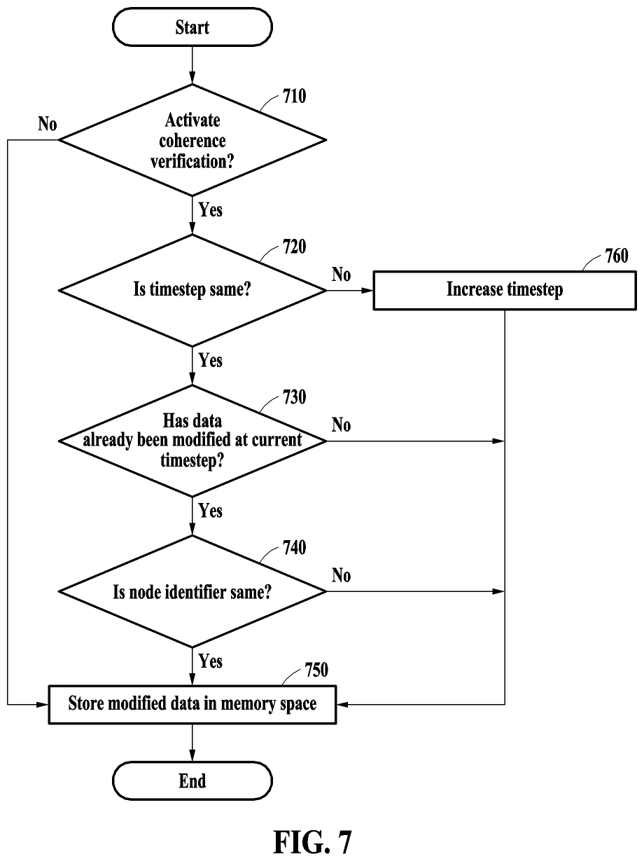

FIG. 7 illustrates a memory management process including data modification based on the bit value of a verification activation bit according to one or more embodiments. Referring to FIG. 7, when a home node receives a write request from a cached node to modify data stored in the memory of the home node, the process of FIG. 7 may begin with operation 710, where the home node determines whether to activate multi-node coherence verification of a multi-node computing system. More specifically, the home node may determine whether to activate multi-node coherence verification of a data space corresponding to data to be modified by the write request, and may do so based on the bit value of a verification activation bit corresponding to the data to be modified by the write request.

When the verification activation bit value indicates deactivation, the home node may deactivate multi-node coherence verification of the data space corresponding to the data to be modified by the write request. If multi-node coherence verification is deactivated, in operation 750, the home node may store data modified by the cached node in the data space in response to the write request without multi-node coherence verification. When the verification activation bit value indicates activation, the home node may activate multi-node coherence verification specifically for the data space corresponding to the data to be modified by the write request.

If multi-node coherence verification is activated, in operation 720, the home node may compare (i) the current timestep with (ii) the data in the count entry (which holds the timestep during which the data was most recently modified by the home node). Since modified data is synchronized across the multi-node computing system each time the current timestep ends, data coherence issues may not occur in the multi-node computing system when data is modified at different timesteps. If the current timestep count is different from the timestep at which the data was most recently modified, in operation 760, the home node may increase the timestep recorded in the count entry. After increasing the timestep recorded in the count entry in operation 760, in operation 750, the home node may store the data modified by the cached node in the data space corresponding to the data to be modified by the write request according to the write request.

If the current timestep count is the same as the timestep at which the data was most recently modified, in operation 730, the home node may determine whether to store the data modified by the cached node in the data space corresponding to the data to be modified by the write request based on a modification bit of a metadata space of the hash table entry corresponding to the data to be modified by the write request. If the bit value of the modification bit indicates that data in the data space corresponding to the data to be modified by the write request has not been modified at the current timestep, in operation 750, the home node may store the data modified by the cached node in the data space corresponding to the data to be modified by the write request.

If the bit value of the modification bit indicates that data in the data space corresponding to the data to be modified by the write request has been modified during the current timestep, in operation 740, the home node may determine whether to store the data modified by the cached node into the data space corresponding to the data to be modified by the write request, and may do so based on (i) the source node identifier of a metadata space corresponding to the data to be modified by the write request and (ii) the node identifier of the cached node. If the source node identifier of the metadata space corresponding to the data to be modified by the write request is the same as the node identifier of the cached node, in operation 750, the home node may store the data modified by the cached node in the data space corresponding to the data to be modified by the write request. If the source node identifier of the metadata space corresponding to the data to be modified by the write request is different from the node identifier of the cached node, the home node may invalidate the data modified by the cached node.

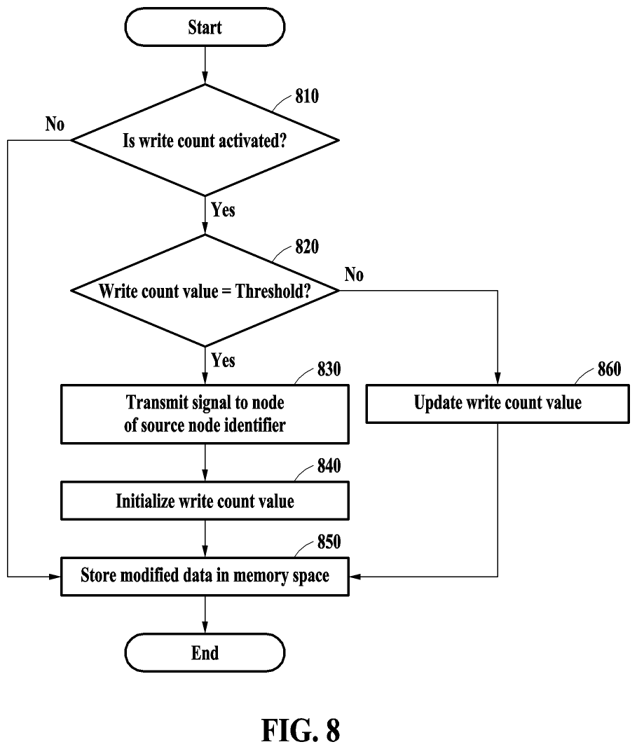

FIG. 8 illustrates a memory management process including an operation of determining whether to transmit a count result signal to a cached node before performing data modification based on the bit value of a count activation bit and the data value of a count bit according to one or more embodiments. Referring to FIG. 8, operation 810 may be performed after a determination to modify data stored in memory of a home node, but before the modification of the stored data is performed. For example, operation 810 may be performed before operation 750 of FIG. 7 is performed. In operation 810, the home node may determine whether a count bit of a metadata space corresponding to data to be modified is activated, and that determination may be based on a count activation bit of a hash table entry corresponding to the data to be modified. If the bit value of the count activation bit indicates deactivation, in operation 850, the home node may store modified data in the memory of the home node.

If the bit value of the count activation bit indicates activation, in operation 820, the home node may compare the data value of the count bit of the metadata space corresponding to the data to be modified with a threshold value. The threshold value may be a value predetermined by a multi-node computing system. For example, the comparison may be performed to check whether the data value of the count bit is equal to, or exceeds, the threshold value. The higher the data value of the count bit, the more the cached node has consecutively modified the data. Therefore, for example, if the data value of the count bit is equal to the threshold value, a count result signal may be transmitted to the cached node. This may signal to the cached node that for a certain number of consecutive timesteps only the cached node has been updating the data. Thus, the cached node may, for example, move the data to the local memory of the cached node based on the count result signal, which may reduce repetitive overhead. The data value of the count bit may be referred to as the write count value.

If the result of comparing the write count value with the threshold value does not meet a predetermined condition, for example, if the write count value is less than the threshold value, in operation 860, the home node may update the write count value. After the write count value is updated, in operation 850, the home node may store the modified data at a memory address.

If the result of comparing the write count value with the threshold value meets the predetermined condition, for example, if the write count value is equal to the threshold value, in operation 830, the home node may, as noted, transmit the count result signal to the cached node attempting to modify the data. After transmitting the count result signal to the cached node, in operation 840, the home node may initialize/reset the write count value (erase the count value). In operation 850, the home node may store the modified data at the memory address.

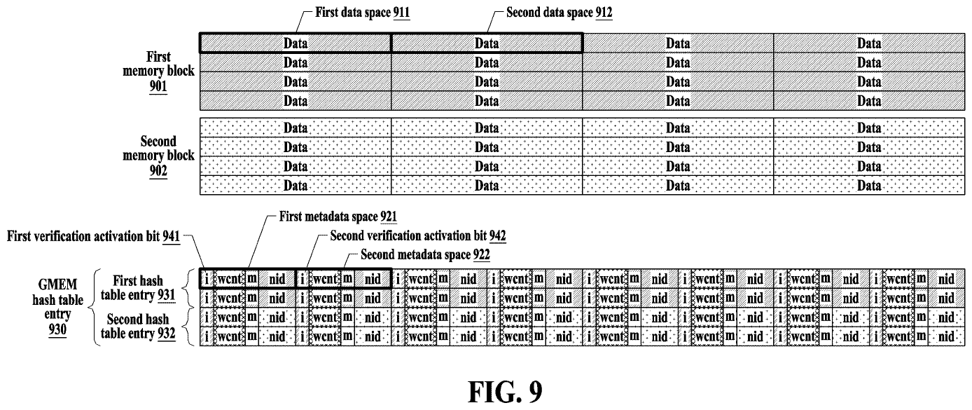

FIG. 9 illustrates a memory space including a verification activation bit in each metadata space of a hash table entry according to one or more embodiments. Referring to FIG. 9, memory of a home node may include a first memory block 901, a second memory block 902, and a GMEM hash table entry 930. The GMEM hash table entry 930 may include a first hash table entry 931 and a second hash table entry 932. The memory blocks 901 and 902 may correspond to the memory blocks 601 and 602 of FIG. 6. The first hash table entry 931 may store metadata corresponding to data stored in the first memory block 901. The second hash table entry 932 may store metadata corresponding to data stored in the second memory block 902.

The GMEM hash table entry 930 may include metadata including a modification bit and a source node identifier. The modification bits and source node identifiers stored in the GMEM hash table entry 930 may be used for multi-node coherence verification corresponding to the data stored in the first memory block 901 and the second memory block 902. A first metadata space 921 may be a metadata space corresponding to a first data space 911. A second metadata space 922 may be a metadata space corresponding to a second data space 912.

The first metadata space 921 may include a first verification activation bit 941. The second metadata space 922 may include a second verification activation bit 942. Unlike the verification activation bit of FIG. 6, the verification activation bits of FIG. 9 may determine whether to activate multi-node coherence verification for individual data spaces of respective metadata spaces. For example, multi-node coherence verification of the first data space 911 may be activated based on the bit value of the first verification activation bit 941 stored in the first metadata space 921, and multi-node coherence verification of the second data space 912 may be activated based on the bit value of the second verification activation bit 942 stored in the second metadata space 922. At this time, a count activation bit may not be stored in the GMEM hash table entry 930.

Although FIG. 9 illustrates an embodiment in which verification activation bits have a one-to-one correspondence with metadata spaces, the number of metadata spaces to which one verification activation bit corresponds is not limited to the embodiment of FIG. 9. For example, a single validation activation bit may determine whether to activate multi-node coherence validation for 4, 8, or 12 metadata spaces.

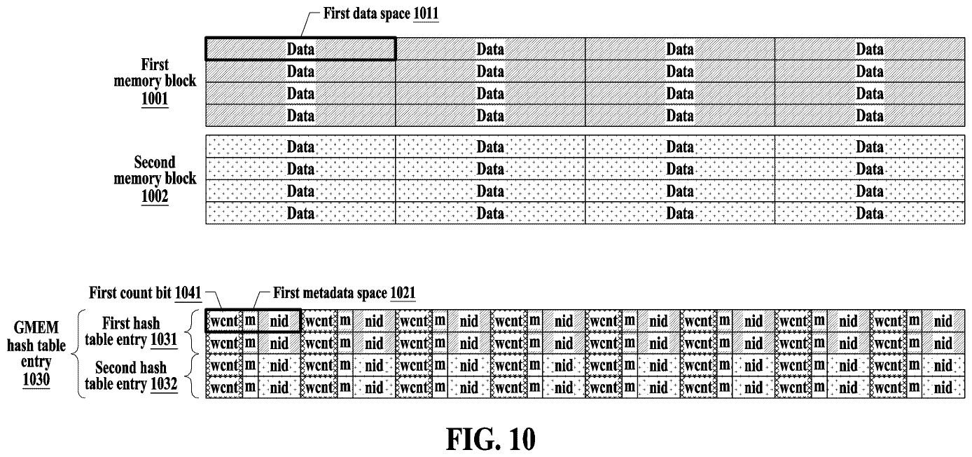

FIG. 10 illustrates a memory space including a count bit in each metadata space of a hash table entry according to one or more embodiments. Referring to FIG. 10, memory of a home node may include a first memory block 1001, a second memory block 1002, and a GMEM hash table entry 1030. The GMEM hash table entry 1030 may include a first hash table entry 1031 and a second hash table entry 1032. The memory blocks 1001 and 1002 may correspond to the memory blocks 901 and 902 of FIG. 9. The first hash table entry 1031 may store metadata corresponding to data stored in the first memory block 1001. The second hash table entry 1032 may store metadata corresponding to data stored in the second memory block 1002.

The GMEM hash table entry 1030 may include metadata including a modification bit and a source node identifier. The modification bits and source node identifiers stored in the GMEM hash table entry 1030 may be used for multi-node coherence verification corresponding to the data stored in the first memory block 1001 and the second memory block 1002. A first metadata space 1021 may be a metadata space corresponding to a first data space 1011.

The first metadata space 1021 may not include a first verification activation bit. Unlike the metadata spaces of FIG. 6, the metadata space of FIG. 10 may use 1 additional bit for the count bit instead of using that bit for the verification activation bit of FIG. 6. For example, if 4 bits are allocated to the first count bit 644 of the first metadata space 621, 5 bits may be allocated to a first count bit 1041 of the first metadata space 1021, and the data value of the first count bit 644 may represent up to “15”, while the data value of the first count bit 1041 may represent up to “31”. In this embodiment, a verification activation bit and a count activation bit may be stored in a memory space different from that of the GMEM hash table entry 1030.

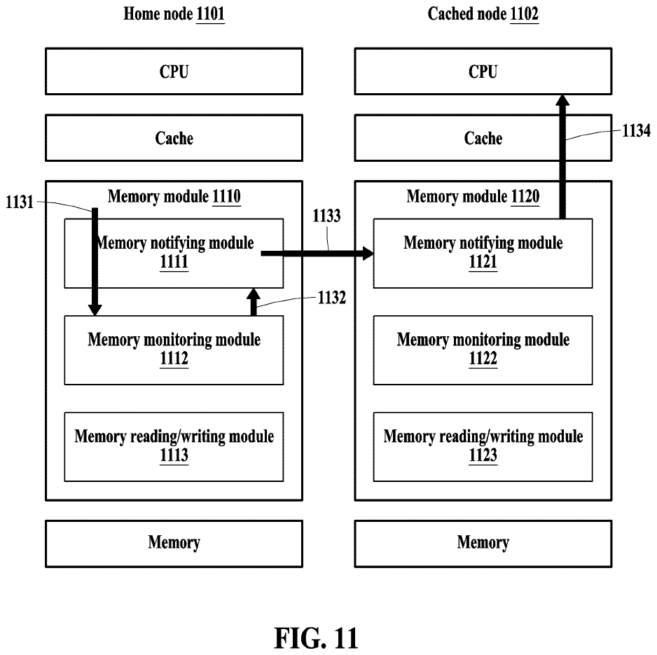

FIG. 11 illustrates the process of transmitting a count result signal from a home node to a cached node according to one or more embodiments. Referring to FIG. 11, if the result of comparing a write count value with a threshold value meets a predetermined condition, a home node 1101 may transmit a count result signal to a cached node 1102. The home node 1101 and cached node 1102 may include memory modules 1110 and 1120, respectively. A memory reading/writing module 1113 or 1123 may be a module to perform data read and data write to memory according to a read request and a write request.

A memory monitoring module 1112 or 1122 may monitor the node identifier of a node that consecutively transmits a data write request. The memory monitoring module 1112 or 1122 may compare the write count value of a count bit of a metadata space of the memory with a threshold value. A memory notifying module 1111 or 1121 may be a module to transmit or receive a count result signal.

For example, when the home node 1101 receives a write request 1131 from the cached node 1102, the write request 1131 may be transmitted to the memory monitoring module 1112. In response to the write request 1131, the memory monitoring module 1112 may transmit the result of comparing the write count value corresponding to data (data to be modified by the write request) with the threshold value to the memory notifying module 1111. If the result of comparing the write count value with the threshold value meets a predetermined condition, the memory notifying module 1111 of the home node 1101 may transmit a count result signal 1133 to the memory notifying module 1121 of the cached node 1102. The memory notifying module 1121 may transmit the count result signal to a CPU of the cached node 1102.

The home node 1101 and/or the cached node 1102 may perform various operations to reduce repetitive overhead based on the count result signal. For example, the cached node 1102 may allocate (i) data in the data space of the memory of the home node 1101 (data which is to be modified by the write request) to (ii) the memory of the cached node, but embodiments are not limited thereto. For example, the cached node 1102 may preload the data.

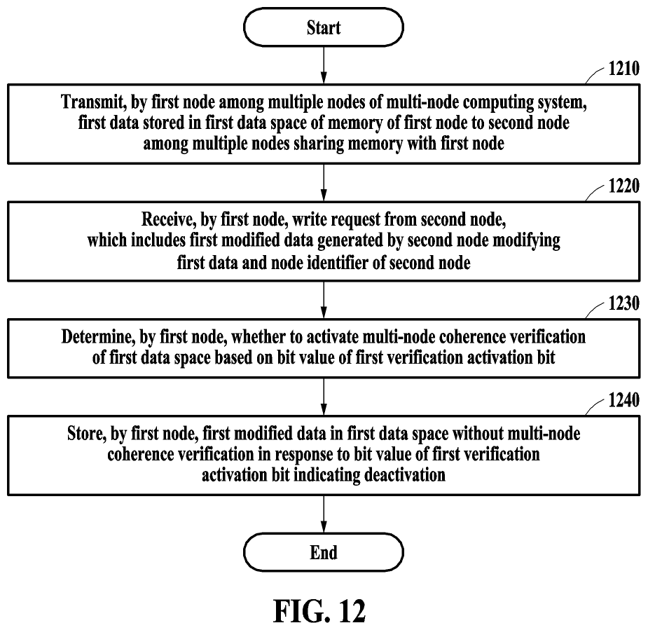

FIG. 12 illustrates a memory management method of a multi-node computing system according to one or more embodiments. Referring to FIG. 12, in operation 1210, a first node among multiple nodes of a multi-node computing system may transmit first data stored in a first data space of memory of the first node to a second node among the multiple nodes sharing memory with the first node.

In operation 1220, the first node of the multi-node computing system may receive a write request from the second node, which includes first modified data generated by the second node modifying the first data and a node identifier of the second node.

In operation 1230, the first node of the multi-node computing system may determine whether to activate multi-node coherence verification of the first data space based on a bit value of a first verification activation bit.

The multi-node coherence verification may include verification to prevent the data stored in the first data space from being modified by various of the nodes within the same timestep. The bit value of the first verification activation bit may be stored in a hash table entry for multi-node coherence verification. Whether to activate multi-node coherence verification of a second data space of the memory of the first node may be determined based on the bit value of a first verification activation bit. The bit value of the second verification activation bit, which determines whether to activate multi-node coherence verification of the second data space of the memory of the first node, may be stored in a second metadata space corresponding to the second data space of the hash table entry. The bit value of the first verification activation bit may be stored in a first metadata space corresponding to the first data space of the hash table entry.

In operation 1240, the first node of the multi-node computing system may store the first modified data in the first data space without multi-node coherence verification; the lack of multi-node coherence verification may be in response to the bit value of the first verification activation bit indicating deactivation. The first node of the multi-node computing system may determine whether to store the first modified data in the first data space based on a first modification bit of the first metadata space corresponding to the first data space of the hash table entry (the first modification bit indicating whether data in the first data space has been modified at a current timestep), and the determining may be in response to the bit value of the first verification activation bit indicating activation.

The first node of the multi-node computing system may store the first modified data in the first data space in response to a data value of the first modification bit indicating that the data in the first data space has not been modified during the current timestep. The first node of the multi-node computing system may determine whether to store the first modified data in the first data space based on a first source node identifier of the first metadata space which indicates a node identifier of a node modifying the data in the first data space, in response to the data value of the first modification bit indicating that the data in the first data space has been modified at the current timestep.

The first node of the multi-node computing system may store the first modified data in the first data space in response to the node identifier of the second node being the same as the first source node identifier. The first node of the multi-node computing system may invalidate the first modified data in response to the node identifier of the second node being different from the first source node identifier.

The first node of the multi-node computing system may compare a threshold value with a write count value indicating the number of times data in the first data space has been consecutively modified by the same node. The first node of the multi-node computing system may transmit a count result signal to the second node based on the comparison result. The first node of the multi-node computing system may determine whether to compare the write count value with the threshold value based on a bit value of a count activation bit. The write count value may be stored in the first metadata space of the hash table entry for multi-node coherence verification of the data in the first data space. The bit value of the count activation bit may be stored in the hash table entry.

The computing apparatuses, the electronic devices, the processors, the memories, the nodes, the information output system and hardware, the storage devices, and other apparatuses, devices, units, modules, and components described herein with respect to FIGS. 1-12 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A memory management method of a multi-node computing system comprising nodes, the memory management method comprising:
transmitting, by a first node among the nodes, to a second node among the nodes, first data stored in a first data space of memory of the first node;
receiving, by the first node, a write request from the second node, wherein the write request comprises first modified data and a node identifier identifying the second node, and wherein the first modified data is generated by the second node modifying the first data;
determining, by the first node, whether to activate multi-node coherence verification with respect to the first data space based on a bit value of a first verification activation bit; and
determining whether to store, by the first node, the first modified data in the first data space without activating the multi-node coherence verification based on the bit value of the first verification activation bit.

2. The memory management method of claim 1, wherein
the multi-node coherence verification comprises verification to prevent data stored in the first data space from being modified by various of the nodes within a same timestep.

3. The memory management method of claim 1, further comprising:
based on the bit value of the first verification activation bit indicating activation, determining, by the first node, whether to store the first modified data in the first data space based on a first modification bit of a first metadata space corresponding to the first data space of a hash table entry, the first modification bit indicating whether data in the first data space has been modified at a current timestep; and
storing, by the first node, the first modified data in the first data space in response to a data value of the first modification bit indicating that the data in the first data space has not been modified during the current timestep.

4. The memory management method of claim 3, further comprising:
based on the data value of the first modification bit indicating that the data in the first data space has been modified at the current timestep, determining, by the first node, whether to store the first modified data in the first data space based on a first source node identifier of the first metadata space, the first node identifier identifying a node, among the nodes, that modified the data in the first data space; and
storing, by the first node, the first modified data in the first data space in response to the node identifier of the second node being the same as the first source node identifier.

5. The memory management method of claim 3, further comprising:
based on the data value of the first modification bit indicating that the data in the first data space has been modified at the current timestep, determining, by the first node, whether to store the first modified data in the first data space based on a first source node identifier of the first metadata space, the first node identifier identifying a node, among the nodes, that modified the data in the first data space; and
invalidating, by the first node, the first modified data in response to the node identifier of the second node being different from the first source node identifier.

6. The memory management method of claim 1, wherein the bit value of the first verification activation bit is stored in a hash table entry that is used for the multi-node coherence verification.

7. The memory management method of claim 6, wherein whether to activate multi-node coherence verification with respect to a second data space of the memory of the first node is determined based on the bit value of the first verification activation bit.

8. The memory management method of claim 6, wherein
a bit value of a second verification activation bit, which determines whether to activate the multi-node coherence verification with respect to the second data space of the memory of the first node, is stored in a second metadata space corresponding to the second data space of the hash table entry, and
the bit value of the first verification activation bit is stored in a first metadata space of the hash table entry, the first metadata space corresponding to the first data space.

9. The memory management method of claim 1, further comprising:
comparing, by the first node, a threshold value with a write count value indicating the number of times data in the first data space has been consecutively modified by a same node; and
based on a result of the comparing, transmitting, by the first node, to the second node, a count result signal,
wherein the write count value is stored in a first metadata space of a hash table entry for the multi-node coherence verification with respect to the data in the first data space.

10. The memory management method of claim 9, further comprising:
based on a bit value of a count activation bit, determining, by the first node, whether to compare the write count value with the threshold value,
wherein the bit value of the count activation bit is stored in the hash table entry.

11. A memory management method of a multi-node computing system comprising nodes, the memory management method comprising:
transmitting, by a first node among the nodes, to a second node among the nodes, first data stored in a first data space of memory of the first node;
receiving, by the first node, a write request from the second node, wherein the write request comprises first modified data and a node identifier identifying the second node, and wherein the first modified data is generated by the second node modifying the first data;
comparing, by the first node, a threshold value with a write count value indicating the number of times data in the first data space has been consecutively modified by a same node;
based on a result of the comparing, transmitting a count result signal from the first node to the second node; and
storing, by the first node, the first modified data in the first data space.

12. The memory management method of claim 11, further comprising:
based on a bit value of a count activation bit, determining, by the first node, whether to compare the write count value with the threshold value,
wherein the write count value and the bit value of the count activation bit are stored in a hash table entry for the multi-node coherence verification of the data in the first data space.

13. A multi-node computing system comprising:
nodes sharing a shared memory, the nodes including a first node and a second node;
wherein the first node is configured to:
transmit first data stored in a first data space of memory of the first node to the second node, the first data space comprised in the shared memory,
receive a write request from the second node, the write request comprising first modified data generated by the second node modifying the first data and a node identifier identifying the second node,
determine whether to activate multi-node coherence verification with respect to the first data space based on a bit value of a first verification activation bit, and
determine whether to store the first modified data in the first data space without activating the multi-node coherence verification based on the bit value of the first verification activation bit.

14. The multi-node computing system of claim 13, wherein the first node is configured to:
based on the bit value of the first verification activation bit indicating activation, determine whether to store the first modified data in the first data space based on a first modification bit of a first metadata space corresponding to the first data space of a hash table entry, the first modification bit indicating whether data in the first data space has been modified at a current timestep, and
store the first modified data in the first data space in response to a data value of the first modification bit indicating that the data in the first data space has not been modified during the current timestep.

15. The multi-node computing system of claim 14, wherein the first node is configured to:
based on the data value of the first modification bit indicating that the data in the first data space has been modified at the current timestep, determine whether to store the first modified data in the first data space based on a first source node identifier of the first metadata space, the first node identifier identifying a node, among the nodes, that modified the data in the first data space, and
store the first modified data in the first data space in response to the node identifier of the second node being the same as the first source node identifier.

16. The multi-node computing system of claim 14, wherein the first node is further configured to:
based on the data value of the first modification bit indicating that the data in the first data space has been modified at the current timestep, determine whether to store the first modified data in the first data space based on a first source node identifier of the first metadata space, the first node identifier identifying a node, among the nodes, that modified the data in the first data space; and
invalidate the first modified data in response to the node identifier of the second node being different from the first source node identifier.

17. The multi-node computing system of claim 13, wherein the bit value of the first verification activation bit is stored in a hash table entry that is used for the multi-node coherence verification.

18. The multi-node computing system of claim 13, wherein whether to activate multi-node coherence verification with respect to a second data space of the memory of the first node is determined based on the bit value of the first verification activation bit.

19. The multi-node computing system of claim 13, wherein the first node is configured to:
compare a threshold value with a write count value indicating the number of times data in the first data space has been consecutively modified by a same node, and
based on a result of the comparing, transmit a count result signal to the second node,
wherein the write count value is stored in a first metadata space of a hash table entry for the multi-node coherence verification with respect to the data in the first data space.

20. The multi-node computing system of claim 19, wherein the first node is further configured to:
based on a bit value of a count activation bit, determine whether to compare the write count value with the threshold, and
the bit value of the count activation bit is stored in the hash table entry.
